(19) United States
(12) Patent Application Publication
(10) Pub. No.: US 2026/0050147 A1
(43) Pub. Date: Feb. 19, 2026

(54) DISPLAY DEVICE FOR WEARING BY A USER

(71) Applicant: RealD Spark, LLC, Boulder, CO (US)

(72) Inventors: Michael G. Robinson, Boulder, CO (US); Graham J. Woodgate, Henley-on-Thames (GB); Jonathan Harrold, Leamington Spa (GB)

(21) Appl. No.: 19/299,243

(22) Filed: Aug. 13, 2025

Related U.S. Application Data
(60) Provisional application No. 63/683,011, filed on Aug. 14, 2024.

(51) Int. Cl. G02B 13/08; F21V 8/00; G02B 27/00; G06F 1/16

(52) U.S. Cl. CPC G02B 13/08; G02B 6/0056; G02B 27/0081; G06F 1/163

(57) ABSTRACT

A device for wearing by a user includes a ring-shaped band sized for extending and fitting around an arm or digit of the user and a near-eye display apparatus attached to the ring-shaped band for displaying an image to the user. The near-eye display apparatus includes a spatial light modulator and an optical apparatus. The spatial light modulator is arranged to output light via the optical apparatus to provide the image for display. The optical apparatus has an optical axis and positive optical power in lateral and transverse directions that are perpendicular to each other and perpendicular to the optical axis. The optical apparatus has anamorphic properties in the lateral and transverse directions.

### CROSS-REFERENCE TO RELATED APPLICATIONS

This application claims the benefit of and priority to U.S. Provisional Patent Application No. 63/683,011, filed Aug. 14, 2024, which is incorporated herein by reference in its entirety and for all purposes.

### TECHNICAL FIELD

This disclosure generally relates to devices incorporating display apparatuses for wearing by a user.

### BACKGROUND

Head-worn displays incorporating a near-eye display apparatus may be arranged to provide fully immersive imagery such as in virtual reality (VR) displays or augmented imagery overlayed over views of the real world such as in augmented reality (AR) displays. If the overlayed imagery is aligned or registered with the real-world image it may be termed Mixed Reality (MR). In VR displays, the near-eye display apparatus is typically opaque to the real world, whereas in AR displays the optical system is partially transmissive to light from the real world.

The near-eye display apparatuses of AR and VR displays aim to provide images to at least one eye of a user with full colour, high resolution, high luminance and high contrast; and with wide fields of view (angular size of image) and large eyebox sizes (the geometry over which the eye can move while having visibility of the full image field of view). Such displays are desirable in thin form factors, low weight and with low manufacturing cost and complexity.

Further, AR near-eye display apparatuses aim to have high transmission of real-world light rays without image distortions or degradations and reduced glare of stray light away from the display wearer. AR optics may broadly be categorised as reflective combiner type or waveguide type. Waveguide types typically achieve reduced form factor and weight due to the optical path folding within the waveguide. Known methods for injecting images into a waveguide may use a spatial light modulator (SLM) and a projection lens arrangement with a prism or grating to couple light into the waveguide. Pixel locations in the SLM are converted to a fan of ray directions by the projection lens. In other arrangements a laser scanner may provide the fan of ray directions. The angular locations are propagated through the waveguide and output to the eye of the user. The eye's optical system collects the angular locations and provides spatial images at the retina.

Devices with displays which are worn by a user on parts of the body other than the head, such as smartwatches, also exist. Such devices typically do not utilise near-eye displays.

### SUMMARY

In an aspect, there is provided a device for wearing by a user, the device comprising a ring-shaped band sized for extending and fitting around an arm or digit of the user and a near-eye display apparatus attached to the ring-shaped band for displaying an image to the user. The near-eye display apparatus comprises a spatial light modulator, and an optical apparatus. The spatial light modulator is arranged to output light via the optical apparatus to provide the image for display. The optical apparatus has an optical axis and positive optical power in lateral and transverse directions that are perpendicular to each other and perpendicular to the optical axis. The optical apparatus has anamorphic properties in the lateral and transverse directions.

A display device may provide images that are private and are not visible to non-users of the displays. The display device may be moved towards the pupil of the observer, and small exit pupil size may be provided while achieving images with reduced image vignetting. The display device may be provided in a small package suitable for wearing on the digit or arm of the user without undesirable bulk. A low power consumption display device may be provided with desirable brightness levels and long battery life. In comparison to head-mounted displays, comfort of wearing may be improved.

The optical apparatus may comprise an extraction waveguide. The waveguide may be conveniently provided within a ring-shaped band in comparison to conventional non-anamorphic optical systems. The extraction waveguide may provide folding of the optical apparatus, reducing bulk.

The spatial light modulator may comprise pixels distributed in the lateral direction. The optical apparatus may comprise a transverse anamorphic component having positive optical power in the transverse direction, wherein the transverse anamorphic component is arranged to receive light from the spatial light modulator and to output light in directions that are distributed in the transverse direction, wherein the extraction waveguide is arranged to receive the light output from the transverse anamorphic component; a lateral anamorphic component having positive optical power in the lateral direction, wherein the extraction waveguide is arranged to guide light from the transverse anamorphic component to the lateral anamorphic component along the extraction waveguide in a first direction; and a light reversing reflector that is arranged to reflect light guided along the extraction waveguide in the first direction such that the reflected light is directed along the extraction waveguide in a second direction opposite to the first direction.

The optical apparatus may provide increased image brightness with desirable size of exit pupil in a small package.

The extraction waveguide may comprise a rear guide surface and a polarisation-sensitive reflector opposing the rear guide surface. The near-eye display apparatus may further comprise a deflection arrangement disposed outside the polarisation-sensitive reflector. The near-eye display apparatus may be arranged to provide light guided along the extraction waveguide in the first direction with an input linear polarisation state before reaching the polarisation-sensitive reflector. The optical apparatus may further comprise a polarisation conversion retarder disposed in the light path between the polarisation-sensitive reflector and the light reversing reflector. The polarisation conversion retarder may be arranged to convert a polarisation state of light passing therethrough between a linear polarisation state and a circular polarisation state. The polarisation conversion retarder and the light reversing reflector may be arranged in combination to rotate the input linear polarisation state of the light guided in the first direction so that the light guided in the second direction and output from the polarisation conversion retarder has a linear polarisation state that is orthogonal to the input linear polarisation state. The polarisation-sensitive reflector may be arranged to reflect light guided in the first direction having the input linear polarisation state so that the rear guide surface and the polarisation-sensitive reflector are arranged to guide light in the first direction, and to extract light guided in the second direction having the orthogonal linear polarisation state so that the extracted light is incident on the deflection arrangement. The deflection arrangement may be arranged to deflect at least part of the light extracted by the polarisation-sensitive reflector that is incident thereon towards an output direction forwards of the near-eye display apparatus. Stray light may be reduced and image contrast improved.

The extraction waveguide may comprise a front guide surface; a polarisation-sensitive reflector opposing the front guide surface; and an extraction element disposed outside the polarisation-sensitive reflector. The extraction element may comprise a rear guide surface opposing the front guide surface; and an array of extraction features. The near-eye display apparatus may be arranged to provide light guided along the extraction waveguide in the first direction with an input linear polarisation state before reaching the polarisation-sensitive reflector. The optical apparatus may further comprise a polarisation conversion retarder disposed between the polarisation-sensitive reflector and the light reversing reflector. The polarisation conversion retarder may be arranged to convert a polarisation state of light passing therethrough between a linear polarisation state and a circular polarisation state. The polarisation conversion retarder and the light reversing reflector may be arranged in combination to rotate the input linear polarisation state of the light guided in the first direction so that the light guided in the second direction and output from the polarisation conversion retarder has an orthogonal linear polarisation state that is orthogonal to the input linear polarisation state. The polarisation-sensitive reflector may be arranged to reflect light guided in the first direction having the input linear polarisation state and to extract light guided in the second direction having the orthogonal linear polarisation state, so that the front guide surface and the polarisation-sensitive reflector are arranged to guide light in the first direction, and the front guide surface and the rear guide surface are arranged to guide light in the second direction. The array of extraction features may be arranged to extract light guided along the extraction waveguide in the second direction towards an eye of a viewer through the front guide surface, the array of extraction features being distributed along the extraction waveguide so as to provide exit pupil expansion in the transverse direction. The cost and complexity of the extraction features may be reduced.

The extraction waveguide may comprise an array of extraction features disposed internally within the extraction waveguide, the extraction features being arranged to transmit light guided along the extraction waveguide in the first direction and to extract light guided along the extraction waveguide in the second direction towards an eye of a viewer, the array of extraction features being distributed along the extraction waveguide so as to provide exit pupil expansion. The thickness of the optical apparatus may be reduced.

The extraction waveguide may comprise an input end, and first and second, opposed guide surfaces for guiding light along the waveguide, the first guide surface being arranged to guide light by total internal reflection and the second guide surface having a stepped shape comprising a plurality of facets extending in a lateral direction across the waveguide and orientated to reflect input light from the input end through the first guide surface as output light, and intermediate regions between the facets that are arranged to direct light through the waveguide without extracting it. The cost and complexity of the waveguide may be reduced.

The extraction waveguide may comprise front and rear guide surfaces arranged to guide light from the transverse anamorphic component along the waveguide; and an extraction reflector arranged to reflect light that has been guided along the waveguide. The extraction reflector may be a lateral anamorphic component having positive optical power in the lateral direction and the extraction reflector may be oriented to extract light out of the waveguide through at least one of the guide surfaces as output illumination. The cost and complexity of the waveguide may be reduced.

The spatial light modulator may comprise inorganic micro-LED pixels or OLED pixels. Image resolution and brightness may be increased.

The ring-shaped band may be sized for extending and fitting around a digit of the user. A thickness of the near-eye display apparatus may be between 0.5 mm and 3 mm and preferably between 0.75 mm and 2 mm.

The ring-shaped band may be sized for extending and fitting around an arm of the use. A thickness of the near-eye display apparatus may be between 0.75 mm and 5 mm and preferably between 1 mm and 3 mm.

The image displayed by the near-eye display apparatus may be monochrome. The cost and complexity of the spatial light modulator may be reduced.

The image may be for projection into the pupil of the eye. A virtual image may be provided that is magnified with respect to the size of the spatial light modulator.

The near-eye display apparatus may be at least partially embedded within the ring-shaped band. The resilience of the near-eye display apparatus may be increased. Comfort of wearing may be increased.

The near-eye display apparatus may be configured to receive electronic signals for displaying the image. Improved functionality may be achieved.

The ring-shaped band may have a gap to enable the ring-shaped band to flex to facilitate close fitting to the digit or arm of the user and/or removal of the ring-shaped band from the digit or arm of the user. Improved user comfort may be achieved.

The device may further comprise a direct view display apparatus. The direct view display apparatus may be arranged to direct light through the near-eye display apparatus. The ring-shaped band may provide increased functionality in a compact form factor.

### BRIEF DESCRIPTION OF THE DRAWINGS

Embodiments are illustrated by way of example in the accompanying FIGURES, in which like reference numbers indicate similar parts, and in which:

FIG. 1A is a schematic diagram illustrating a side view of a device for wearing by a user comprising a ring-shaped band and a near-eye display apparatus;

FIG. 1B is a schematic diagram illustrating a perspective view of the ring-shaped band with the near-eye display apparatus of FIG. 1A;

FIG. 1C is a schematic diagram illustrating a front view of the ring-shaped band with the near-eye display apparatus of FIGS. 1A and 1B;

FIG. 1D is a schematic diagram illustrating a side view of the ring-shaped band on a digit of the user with the near-eye display apparatus in use by a user;

FIG. 1E is a schematic diagram illustrating a side view of the ring-shaped band on a wrist of the user with the near-eye display apparatus in use by a user;

FIG. 2A is a schematic diagram illustrating a perspective view of an anamorphic near-eye display apparatus (ANEDA);

FIG. 2B is a schematic diagram illustrating a perspective view of the coordinate system arrangements for the ANEDA of FIG. 2A;

FIG. 2C is a schematic diagram illustrating a perspective view of the use of a device comprising an ANEDA as the near-eye display apparatus of FIGS. 1A-C;

FIG. 2D is a schematic diagram illustrating a side view of an ANEDA according to a first embodiment;

FIG. 2E is a schematic diagram illustrating a front view of the ANEDA according to the first embodiment of FIG. 2D;

FIG. 3A is a schematic diagram illustrating a side view of propagation of light in an ANEDA;

FIG. 3B is a schematic diagram illustrating a front view of propagation of light in an ANEDA;

FIG. 3C is a schematic diagram illustrating a front view of a spatial light modulator comprising red, green and blue sub-pixels for use in an anamorphic near-eye display device;

FIG. 3D is a schematic diagram illustrating a front view of a spatial light modulator comprising monochromatic sub-pixels for use in an anamorphic near-eye display device;

FIG. 4A is a schematic diagram illustrating a side view of an ANEDA according to a second embodiment;

FIG. 4B is a schematic diagram illustrating a side view of an ANEDA according to a third embodiment;

FIG. 5 is a schematic diagram illustrating a side view of an ANEDA according to a fourth embodiment;

FIG. 6 is a schematic diagram illustrating a side view of an ANEDA according to a fifth embodiment;

FIG. 7 is a schematic diagram illustrating a side view of an ANEDA according to a sixth embodiment;

FIG. 8 is a schematic diagram illustrating a perspective front view of the ANEDA according to the sixth embodiment;

FIG. 9A is a schematic diagram illustrating a front view of the ring-shaped band with the near-eye display apparatus being worn on a digit of a user;

FIG. 9B is a schematic diagram illustrating a perspective side view of the ring-shaped band with the near-eye display apparatus being worn on a digit of a user and providing an image to an eye of the user;

FIG. 10A is a schematic diagram illustrating a side view of ring-shaped band, an ANEDA and further comprising a direct view display apparatus;

FIG. 10B is a schematic diagram illustrating a side view of an alternative ring-shaped band, comprising an ANEDA and a direct view display apparatus; and

FIG. 10C is a schematic diagram illustrating a perspective side view of a user using the direct view display apparatus of FIG. 10A in a direct view mode.

### DETAILED DESCRIPTION

Terms related to optical retarders for the purposes of the present disclosure will now be described.

In a layer comprising a uniaxial birefringent material there is a direction governing the optical anisotropy whereas all directions perpendicular to it (or at a given angle to it) have equivalent birefringence.

The optical axis of an optical retarder refers to the direction of propagation of a light ray in the uniaxial birefringent material in which no birefringence is experienced. This is different from the optical axis of an optical system which may for example be parallel to a line of symmetry or normal to a display surface along which a principal ray propagates.

For light propagating in a direction orthogonal to the optical axis, the optical axis is the slow axis when linearly polarized light with an electric vector direction parallel to the slow axis travels at the slowest speed. The slow axis direction is the direction with the highest refractive index at the design wavelength. Similarly the fast axis direction is the direction with the lowest refractive index at the design wavelength.

For positive dielectric anisotropy uniaxial birefringent materials, the slow axis direction is the extraordinary axis of the birefringent material. For negative dielectric anisotropy uniaxial birefringent materials, the fast axis direction is the extraordinary axis of the birefringent material.

The terms half a wavelength and quarter a wavelength refer to the operation of a retarder for a design wavelength λ₀ that may typically be between 500 nm and 570 nm. In the present illustrative embodiments exemplary retardance values are provided for a wavelength of 550 nm unless otherwise specified.

The retarder provides a phase shift between two perpendicular polarization components of the light wave incident thereon and is characterized by the amount of relative phase, Γ, that it imparts on the two polarization components; which is related to the birefringence Δn and the thickness d of the retarder with retardance Δn·d by:

$$Γ = 2 \cdot π \cdot Δ n \cdot d / {λ}_{0} \qquad eqn . 1$$

In eqn. 1, Δn is defined as the difference between the extraordinary and the ordinary index of refraction, i.e.

$$Δ n = {n}_{e} - {n}_{o} \qquad eqn . 2$$

For a half-wave retarder, the relationship between d, Δn, and λ₀ is chosen so that the phase shift between polarization components is Γ=π. For a quarter-wave retarder, the relationship between d, Δn, and λ₀ is chosen so that the phase shift between polarization components is Γ=π/2.

Some aspects of the propagation of light rays through a transparent retarder between a pair of polarisers will now be described.

The state of polarisation (SOP) of a light ray is described by the relative amplitude and phase shift between any two orthogonal polarization components. Transparent retarders do not alter the relative amplitudes of these orthogonal polarisation components but act only on their relative phase. Providing a net phase shift between the orthogonal polarisation components alters the SOP whereas maintaining net relative phase preserves the SOP. In the current description, the SOP may be termed the polarisation state.

A linear SOP has a polarisation component with a non-zero amplitude and an orthogonal polarisation component which has zero amplitude. A p-polarisation state is a linear polarisation state that lies within the plane of incidence of a ray comprising the p-polarisation state, and a s-polarisation state is a linear polarisation state that lies orthogonal to the plane of incidence of a ray comprising the p-polarisation state. For a linearly polarised SOP incident onto a retarder, the relative phase Γ is determined by the angle between the optical axis of the retarder and the direction of the polarisation component.

A linear polariser transmits a unique linear SOP that has a linear polarisation component parallel to the electric vector transmission direction of the linear polariser and attenuates light with a different SOP. The term “electric vector transmission direction” refers to a non-directional axis of the polariser parallel to which the electric vector of incident light is transmitted, even though the transmitted “electric vector” always has an instantaneous direction. The term “direction” is commonly used to describe this axis.

Absorbing polarisers are polarisers that absorb one polarisation component of incident light and transmit a second orthogonal polarisation component. Examples of absorbing linear polarisers are dichroic polarisers.

Reflective polarisers are polarisers that reflect one polarisation component of incident light and transmit a second orthogonal polarisation component. Examples of reflective polarisers that are linear polarisers are multilayer polymeric film stacks such as DBEF™ or APF™ from 3M Corporation, or wire grid polarisers such as ProFlux™ from Moxtek. Reflective linear polarisers may further comprise cholesteric reflective materials and a quarter-wave retarder arranged in series.

A retarder arranged between a linear polariser and a parallel linear analysing polariser that introduces no relative net phase shift provides full transmission of the light other than residual absorption within the linear polariser.

A retarder that provides a relative net phase shift between orthogonal polarisation components changes the SOP and provides attenuation at the analysing polariser.

Achromatic retarders may be provided wherein the material of the retarder is provided with a retardance Δn·d that varies with wavelength λ as

$$Δ n \cdot d / λ = κ \qquad eqn . 3$$

where κ is substantially a constant.

Examples of suitable materials include modified polycarbonates from Teijin Films. Achromatic retarders may be provided in the present embodiments to advantageously minimise colour changes between polar angular viewing directions which have low luminance reduction and polar angular viewing directions which have increased luminance reductions.

Various other terms used in the present disclosure related to retarders and to liquid crystals will now be described.

A liquid crystal cell has a retardance given by Δn·d where Δn is the birefringence of the liquid crystal material in the liquid crystal cell and d is the thickness of the liquid crystal cell, independent of the alignment of the liquid crystal material in the liquid crystal cell.

Homogeneous alignment refers to the alignment of liquid crystals in switchable liquid crystal displays where molecules align substantially parallel to a substrate. Homogeneous alignment is sometimes referred to as planar alignment. Homogeneous alignment may typically be provided with a small pre-tilt such as 2 degrees, so that the molecules at the surfaces of the alignment layers of the liquid crystal cell are slightly inclined. Pretilt is arranged to minimise degeneracies in switching of cells.

In the present disclosure, homeotropic alignment is the state in which rod-like liquid crystalline molecules align substantially perpendicularly to the substrate. In discotic liquid crystals, homeotropic alignment is defined as the state in which an axis of the column structure, which is formed by disc-like liquid crystalline molecules, aligns perpendicularly to a surface. In homeotropic alignment, pretilt is the tilt angle of the molecules that are close to the alignment layer and is typically close to 90 degrees and for example may be 88 degrees.

In a twisted liquid crystal layer, a twisted configuration (also known as a helical structure or helix) of nematic liquid crystal molecules is provided. The twist may be achieved by means of a non-parallel alignment of alignment layers. Further, cholesteric dopants may be added to the liquid crystal material to break degeneracy of the twist direction (clockwise or anti-clockwise) and to further control the pitch of the twist in the relaxed (typically undriven) state. A supertwisted liquid crystal layer has a twist of greater than 180 degrees. A twisted nematic layer used in SLMs typically has a twist of 90 degrees.

Liquid crystal molecules with positive dielectric anisotropy are switched from a homogeneous alignment (such as an A-plate retarder orientation) to a homeotropic alignment (such as a C-plate or O-plate retarder orientation) by means of an applied electric field.

Liquid crystal molecules with negative dielectric anisotropy are switched from a homeotropic alignment (such as a C-plate or O-plate retarder orientation) to a homogeneous alignment (such as an A-plate retarder orientation) by means of an applied electric field.

Rod-like molecules have a positive birefringence so that nₑ>nₒ as described in eqn. 2. Discotic molecules have negative birefringence so that nₑ<nₒ.

Positive retarders such as A-plates, positive O-plates and positive C-plates may typically be provided by stretched films or rod-like liquid crystal molecules. Negative retarders such as negative C-plates may be provided by stretched films or discotic-like liquid crystal molecules.

Parallel liquid crystal cell alignment refers to the alignment direction of homogeneous alignment layers being parallel or more typically antiparallel. In the case of pre-tilted homeotropic alignment, the alignment layers may have components that are substantially parallel or antiparallel. Hybrid aligned liquid crystal cells may have one homogeneous alignment layer and one homeotropic alignment layer. Twisted liquid crystal cells may be provided by alignment layers that do not have parallel alignment, for example oriented at 90 degrees to each other.

The structure and operation of various anamorphic near-eye display devices will be described herein. In this description, common elements have common reference numerals. It is noted that the disclosure relating to any element applies mutatis mutandi to each device in which the same or corresponding element is provided. Accordingly, for brevity such disclosure is not repeated. Similarly, the various features of any of the following examples may be combined together in any combination.

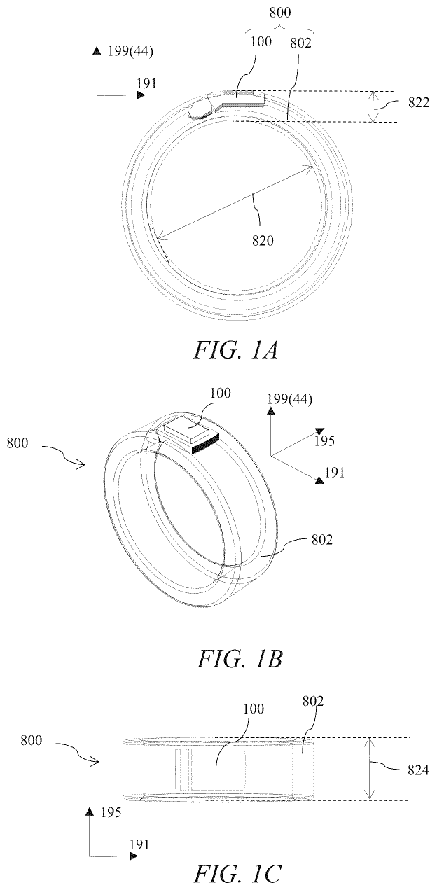

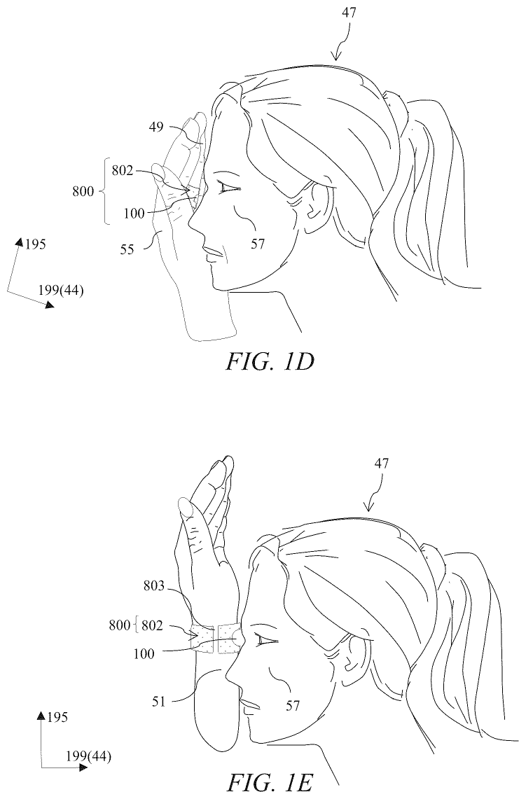

FIG. 1A is a schematic diagram illustrating a side view of a device 800 for wearing by a user comprising a ring-shaped band 802 and a near-eye display apparatus 100; FIG. 1B is a schematic diagram illustrating a perspective view of the ring-shaped band 802 with the near-eye display apparatus 100 of FIG. 1A; and FIG. 1C is a schematic diagram illustrating a front view of the ring-shaped band 802 with the near-eye display apparatus 100 of FIGS. 1A-B; FIG. 1D is a schematic diagram illustrating a side view of the ring-shaped band 802 on a digit of the user 47 with the near-eye display apparatus 100 in use by a user 47; and FIG. 1E is a schematic diagram illustrating a side view of the ring-shaped band 802 on a wrist 51 of the user 47 with the near-eye display apparatus 100 in use by a user 47.

As illustrated in FIG. 1D, the ring-shaped (or annular) band 802 is sized for extending and fitting around a digit 49 (e.g. finger or thumb) of the user 47. Alternatively, as illustrated in FIG. 1E the ring-shaped band 802 may be sized for extending and fitting around an arm 51 (e.g. wrist or lower arm) of the user 47. Either way, a near-eye display apparatus 100 is attached to the ring-shaped band 802 for displaying an image 36 to the user 47.

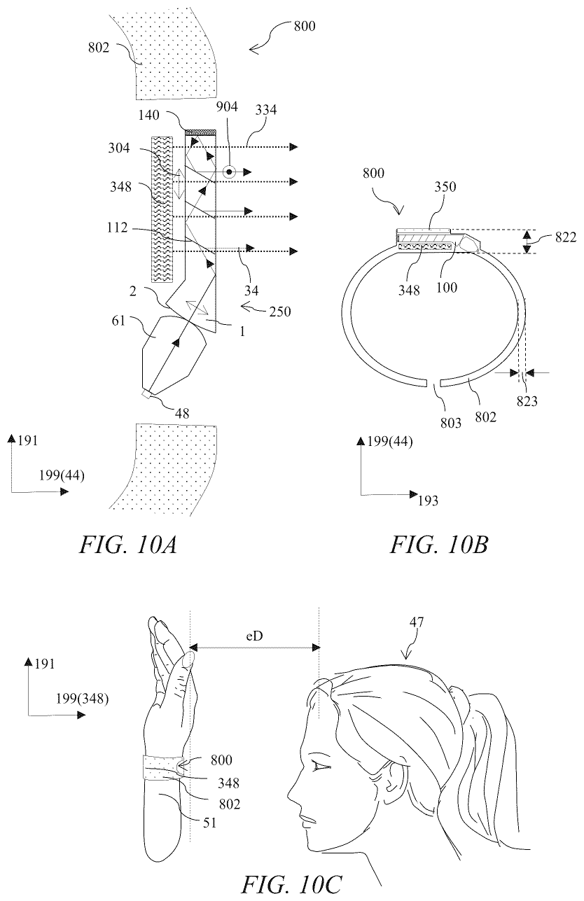

In the embodiment of FIGS. 1A-C, the ring-shaped band 802 forms a continuous loop of material, and the near-eye display apparatus 100 is embedded in the ring-shaped band 802. It will be appreciated that the ring-shaped band 802 may be manufactured from any appropriate material or combination of materials, e.g. materials commonly used for rings or armbands such as metal, wood, plastic etc. The thickness 822 of the ring-shaped band 802 may be arranged to provide a recess for incorporating the near-eye display apparatus 100. As illustrated in FIG. 10B hereinbelow for example, the thickness 822 of the ring-shaped band 802 may vary around the circumference of the ring-shaped band 802.

In the alternative structure of FIG. 1E, the ring-shaped band 802 has a gap 803 to enable the ring-shaped band to flex to facilitate close fitting to the digit or arm of the user and/or removal of the ring-shaped band 802 from the digit or arm of the user. More specifically, the ring-shaped band 802 in this embodiment does not form a continuous loop of material and the near-eye display apparatus 100 is located in the gap 803 while being attached to the ring-shaped band 802 at a first side 803a of the gap 803. The ring-shaped band 802 is not attached at the opposing, second side 803b of the gap 803. This consequently leaves a space to allow the ring-shaped band 802 to flex as described above. When putting on or removing the ring-shaped band 802 of this embodiment, the user is advantageously able to flex the ring-shaped band 802 to enlarge the space into which to place their digit or arm, thereby facilitating the process of putting on or taking off the ring-shaped band 802. In alternative embodiments, the ring-shaped band 802 may further comprise a clasp or adjustable strap.

While wearing the ring-shaped band 802 on a digit 49 as illustrated in FIG. 1D, the user 47 may bring their hand 55 close to their face 57 to view the image 36 provided by the near-eye display apparatus 100. Similarly, while wearing the alternatively sized ring-shaped band 802 on an arm 51, the user 47 may bring their arm close to their face 57 to view the image 36 provided by the near-eye display apparatus 100. In this way, the user 47 is provided with a privacy display which can be worn on their hand 55 or arm 51.

FIGS. 1D-E illustrate that the user 47 is able to view an image privately as the near-eye display 100 that is very close to the head of the user 47 and projects an image directly into the eye of the user 47.

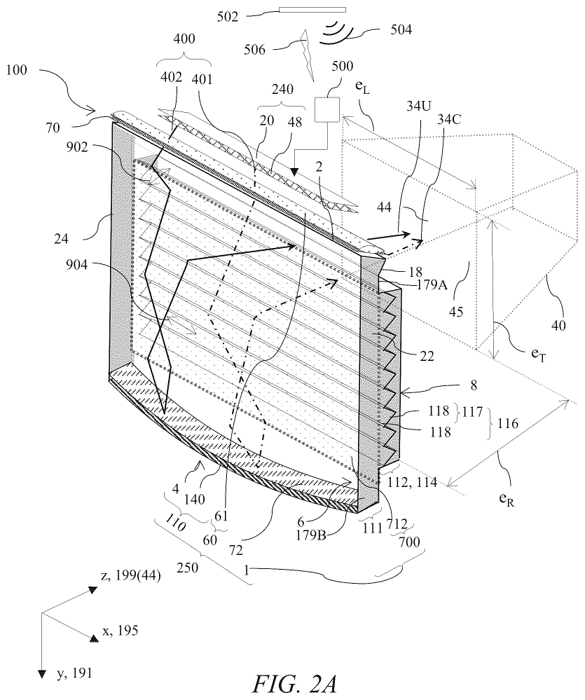

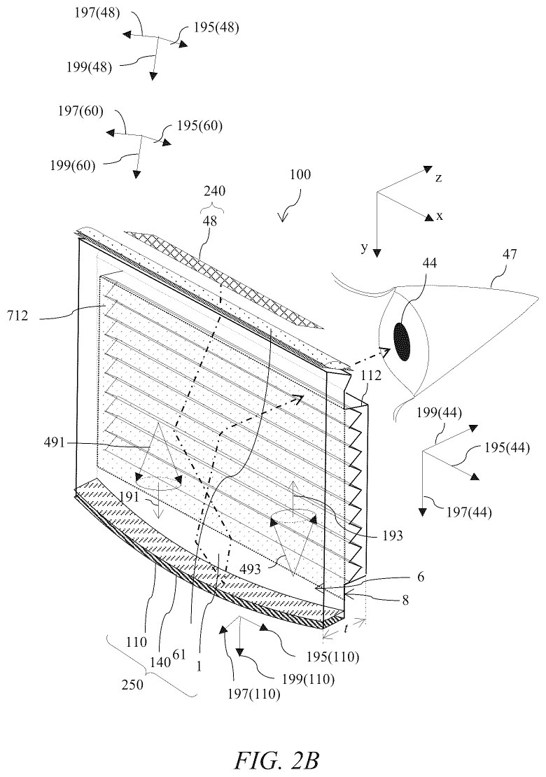

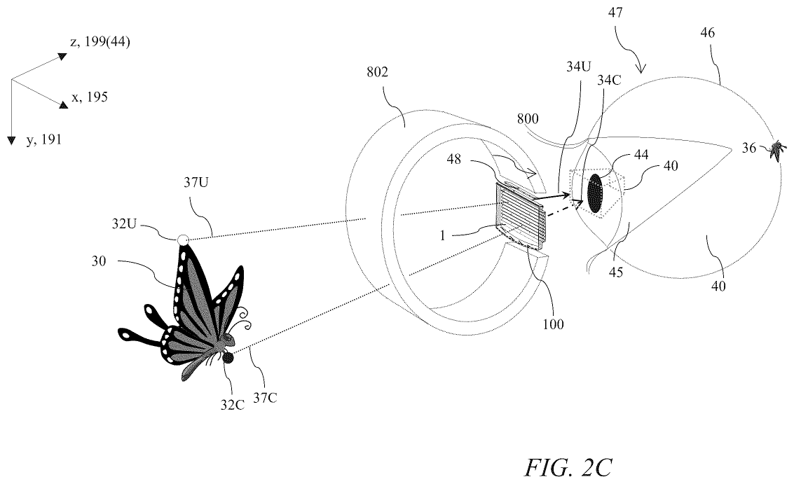

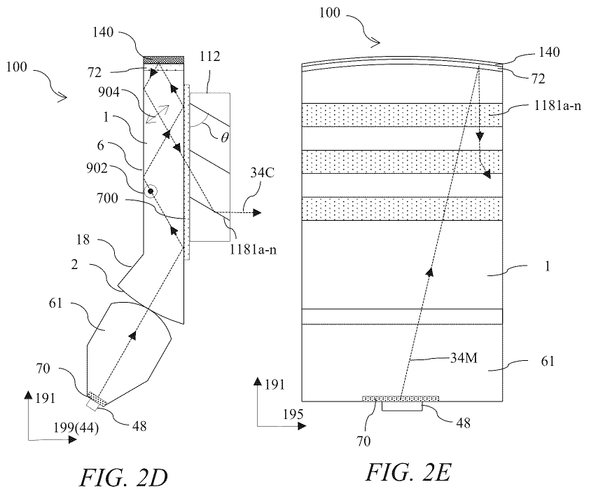

The near-eye display apparatus 100 of the present embodiments is an anamorphic near-eye display apparatus (ANEDA). Various different possible structures for the near-eye display apparatus 100 will now be described with reference to FIG. 2A to FIG. 8.

FIG. 2A is a schematic diagram illustrating a rear perspective view of an ANEDA 100; FIG. 2B is a schematic diagram illustrating a rear perspective view of the coordinate system arrangements for the ANEDA 100 of FIG. 2A; and FIG. 2C is a schematic diagram illustrating a perspective view of the use of a device 800 comprising an ANEDA as the near-eye display apparatus 100 of FIGS. 1A-C. Features of the embodiments of FIGS. 2A-C not discussed in further detail may be assumed to correspond to the features with equivalent reference numerals as discussed above, including any potential variations in the features.

FIGS. 2A and 2B illustrate an ANEDA 100 provided near to an eye 45, to provide light to an exit pupil 40. In use, the pupil 44 of the eye 45 of a viewer 47 is arranged in the exit pupil 40.

ANEDA 100 of the type of FIGS. 2A-B and variations thereof are described in U.S. patent application Ser. No. 18/734,222 filed Jun. 5, 2024, and titled “Anamorphic directional illumination device” (Atty. Dkt. No. 143409-0999), which is herein incorporated by reference in its entirety.

In an illustrative embodiment, the eye 45 of the user 47 may be arranged at a nominal viewing distance er of between 3 mm and 20 mm and preferably between 4 mm and 10 mm from the output surface of the ANEDA 100. Such displays are distinct from direct view displays wherein the viewing distance is typically greater than 100 mm. The nominal viewing distance er may be referred to as the eye relief.

The ANEDA 100 comprises an illumination system 240 comprising a spatial light modulator (SLM) 48 and arranged to output light and an optical apparatus 250 arranged to direct light from the illumination system 240 to the eye 45 of a viewer 47. The illumination system 240 is arranged to output light rays 400 including illustrative light rays 401, 402 that are input into the optical apparatus 250 and are output towards the pupil 44 of the eye 45 as rays 34C, 34U respectively. The SLM 48 may be configured to provide monochrome or full colour light. The SLM 48 may comprise inorganic micro-LED pixels or OLED pixels or may comprise an illuminated liquid crystal display.

In operation, it is desirable that the spatial pixel data provided on the SLM 48 is directed to the pupil 44 of the eye 45 as angular pixel data. As illustrated in FIG. 2C, the lens of the eye 45 of the viewer 47 relays the angular pixel data to spatial pixel data as image 36 at the retina 46 of the eye 45 to provide a perceived virtual image 30 with virtual light rays 37U, 37C provided by respective output light rays 34U, 34C from the ANEDA 100.

In the ANEDA 100, the pixels 222 provide image data for the eye 45 of the viewer 47. The pupil 44 of the eye 45 of the viewer 47 is located in a spatial volume near to the ANEDA 100 commonly referred to as the exit pupil 40, that may alternatively be described as the eyebox. When the pupil 44 is located within the exit pupil 40, the viewer 47 is provided with a full image without missing parts of the image, that is the image does not appear to be vignetted at the retina 46 of the eye 45 of the viewer 47. In the present description, the term vignetting refers to images 36 for which at least some of the image has reduced luminance or no image visibility. For example, the edges of the image 36 may have lower luminance than the centre of the image or may not be visible when the image is vignetted.

The shape of the exit pupil 40 is determined at least by the anamorphic imaging properties of the ANEDA and the respective aberrations of the anamorphic optical apparatus 250. The exit pupil 40 at the eye relief distance er may have dimension e_{L} in the lateral direction 195 and dimension e_{T} in the transverse direction 197. The maximum eye relief distance e_{Rmax} refers to the maximum distance of the pupil 44 from the ANEDA 100 wherein no image vignetting is present. In the present embodiment, increasing the size of the exit pupil 40 refers to increasing the dimensions e_{L}, e_{T}. Increased exit pupil 40 size achieves an increased viewer freedom and an increase in e_{Rmax}.

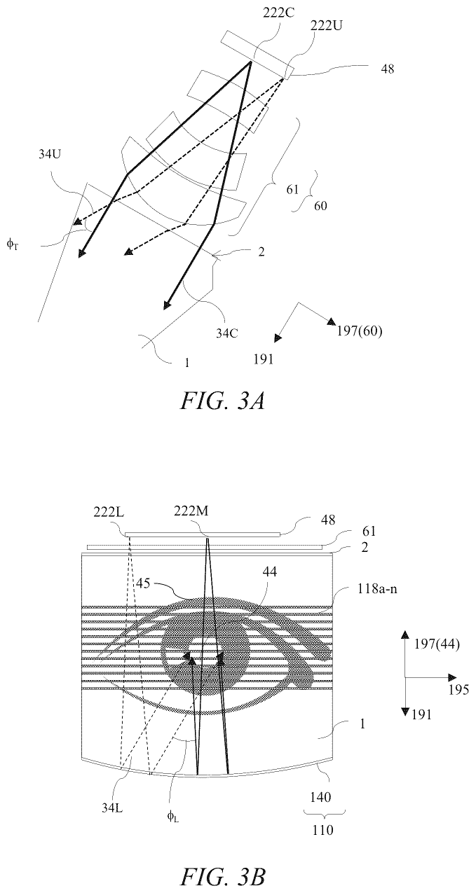

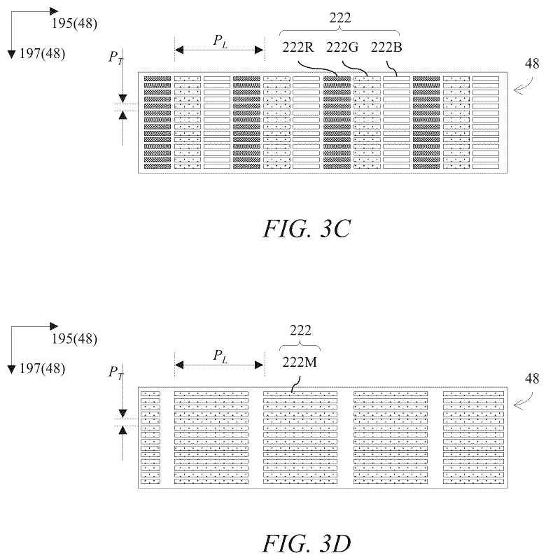

As illustrated in FIGS. 3C-D hereinbelow, the SLM 48 comprises pixels 222 distributed at least in the lateral direction 195. In the illustrative embodiment of FIG. 2A, the illumination system 240 comprises a transmissive SLM 48 comprising an array of spatially separated pixels 222 distributed in a lateral direction 195(48) and transverse direction 197(48). In the embodiment of FIG. 2A, the SLM 48 is a TFT-LCD and illumination system 240 further comprises a backlight 20 arranged to illuminate the SLM 48.

The near-eye display apparatus 100 may be configured to receive electronic signals for displaying the image 36. The ANEDA 100 further comprises a control system 500 arranged to operate the illumination system 240 to provide light that is spatially modulated in accordance with image data representing an image. Control system 500 may communicate via protocols with external controller 502 by signals 504 including but not limited to one or more of the following wireless RF or optical communication types: Wi-Fi, Bluetooth, Bluetooth Low Energy, Zigbee in order to provide either or both data and control signals. The operating power for the device may be stored in the device in an internal battery (not shown) or capacitor or super capacitor (not shown). Such storage means may accumulate energy over a period of time including when the device is not actively displaying an image. The power transfer 506 may be for example by rectifying wireless RF energy or photovoltaics. The power transfer 506 may be by known wired charging or wireless charging means including but not limited to inductive, resonant inductive and magnetic resonance and may incorporate a receiving coil structure (not shown) to facilitate this. Alternatively, or additionally the power transfer 506 may be provided by mechanical motion such as the typical movement of the device on the body and including but not limited to means such as by an internal magnet (not shown) moving in an internal coil (not shown).

The optical apparatus 250 comprises a transverse anamorphic component 60 comprising transverse lens 61 in the embodiment of FIG. 2A, as discussed below. The transverse lens 61 comprises a cylindrical lens in this example.

The transverse anamorphic component 60 is arranged to receive light rays 400 from the SLM 48. The illumination system 240 is arranged so that light output from the transverse anamorphic component 60 is directed in directions that are distributed in the transverse direction 197(60).

In the embodiment of FIG. 2A, the transverse anamorphic component 60 is a transverse lens 61 that is extended in a lateral direction 195(60) parallel to the lateral direction 195(48) of the SLM 48. The transverse anamorphic component 60 that is lens 61 has positive optical power in a transverse direction 197 (60) that is parallel to the direction 197(48) and orthogonal to the lateral direction 195(60); and no optical power in the lateral direction 195(60).

In the present disclosure, the term lens most generally refers to a single lens element or most commonly a compound lens (group of lens elements); and is arranged to provide optical power. A lens may comprise a single refractive surface, multiple refractive surfaces, reflective surfaces or may comprise a catadioptric lens element that combines refractive and reflective surfaces. A lens may further or alternatively comprise diffractive optical elements. A transverse lens is a lens that provides optical power in the transverse direction. Typically a transverse lens provides no optical power in the lateral direction. A transverse lens may be termed a cylindrical lens, although the profile in cross section of the surface or surfaces providing optical power may be different to a segment of a circle, for example paraboidal, elliptical or aspheric. Advantageously aberrations in the transverse direction 197 may be improved and thickness reduced.

The optical apparatus 250 further comprises an extraction waveguide 1 arranged to receive light from the transverse lens 61 and arranged to guide light rays 400 in cone 491 from the transverse lens 61 to a lateral anamorphic component 110 along the extraction waveguide 1 in a first direction 191. The lateral anamorphic component 110 has positive optical power in the lateral direction 195.

The extraction waveguide 1 comprises a rear guide surface 6 and a polarisation-sensitive reflector (PSR) 700 opposing the rear guide surface 6. The extraction waveguide 1 comprises waveguide member 111 arranged between the rear guide surface 6 and the PSR 700, wherein light guides through the waveguide member 111 in the first direction 191.

One example of a PSR 700 is a dichroic stack 712 and another example is a reflective polariser.

The extraction waveguide 1 further has an input end 2 extending in the lateral and transverse directions 195(60), 197(60), the extraction waveguide member 111 of the waveguide 1 being arranged to receive light 400 from the illumination system 240 through the input end 2. The input end 2 extends in the lateral direction 195 between edges 22, 24 of the extraction waveguide 1, and extends in the transverse direction between opposing surfaces of the extraction waveguide 1 waveguide member 111.

The optical apparatus 250 further comprises a light reversing reflector 140 arranged to reflect the light rays 400 in light cones 491 that have been guided along the extraction waveguide 1 in the first direction 191. FIG. 2B illustrates that the reflected light rays 400 in light cone 493 with polarisation state 904 is light that is formed to be guided along the extraction waveguide 1 in a second direction 193 opposite to the first direction 191 and so that reflected cone 493 is guided back through the extraction waveguide 1.

In the embodiment of FIGS. 2A-B, the light reversing reflector 140 is a reflective end 4 of the extraction waveguide 1. Furthermore, the lateral anamorphic component 110 comprises the light reversing reflector 140. The reflective end 4 of the extraction waveguide 1 has a curved shape in the lateral direction 195 that provides positive optical power, affecting the light rays in cone 491 in the lateral direction 195(110), and no power in the transverse direction 197(110). The optical apparatus 250 is thus arranged so that light output from the lateral anamorphic component 110 is directed in directions that are distributed in the transverse direction 197(110) and the lateral direction 195(110). The curved shape of the reflective end 4 may be a shape that is the cross section of a sphere, ellipse, parabola or other aspheric shape to achieve desirable imaging of light rays from the SLM 48 to the pupil 44 of the eye 45.

PSR 700 may not extend along the entirety of the waveguide member 111. Waveguide member 111 guiding regions 179A, 179B may be arranged along the waveguide member 111 between an input end 2 and the PSR 700, and between the PSR 700 and light reversing reflector 140. The front guide surface 8 of the extraction waveguide 1 may comprise the guiding regions 179A, 179B.

The ANEDA 100 further comprises a deflection arrangement 112 disposed outside the PSR 700, in other words the PSR 700 is arranged between the deflection arrangement 112 and waveguide member 111.

The deflection arrangement 112 comprises a deflection element 116 comprising an array of deflection features 118 that are arranged to deflect light incident thereon forwards of the ANEDA 100 and towards the output direction 199(44) wherein the deflection features 118 are reflectors 117. The deflection element 116 is arranged to direct the deflected light towards an eye 45 of the viewer 47 in front of the ANEDA 100.

It is desirable to increase the size of the eyebox 40. The array of deflection features 118a-n are distributed in the direction 193 across the waveguide 1 and may be a spatially separated array of deflection features 118a-n. Such spatially separated deflection features 118a-n may achieve an expansion of the size er of the eyebox or exit pupil 40 in the transverse direction 197. The freedom of the location of the eye 45 with respect to the ANEDA 100 may be advantageously increased in a thin package size while maintaining full image 36 visibility.

By comparison with ANEDA 100 comprising a single deflection feature, such as illustrated by the single facet 12 of FIG. 6 hereinbelow, the thickness of the ANEDA 100 may be advantageously reduced for a desirable size er of the eyebox 40 in the transverse direction 197.

The output direction 199(44) may be a nominal direction 199(44) for light rays 34 from a point 230 on the central pixel 222C of the SLM 48.

The principle of operation of the ANEDA 100 will now be further described. The optical apparatus 250 has an optical axis 199 and has anamorphic properties in a lateral direction 195 and in a transverse direction 197 that are perpendicular to each other and perpendicular to the optical axis 199.

Mathematically expressed, for any location within the ANEDA 100, the optical axis direction 199 may be referred to as the O unit vector, the transverse direction 197 may be referred to as the T unit vector and the lateral direction 195 may be referred to as the L unit vector wherein the optical axis direction 199 is the crossed product of the transverse direction 197 and the lateral direction 195;

$$O = T \times L \qquad eqn . 4$$

Various surfaces of the ANEDA 100 transform or replicate the optical axis direction 199; however, for any given ray; the expression of eqn. 4 may be applied.

FIG. 2B illustrates the variation of optical axis 199 direction, lateral direction 195 and transverse direction 197 as light rays propagate through the optical apparatus 250. In the present description, the lateral and transverse directions 195, 197 are defined relative to the optical axis 199 direction in any part of the illumination system 240 or optical apparatus 250, and are not in constant directions in space. In the embodiment of FIG. 2B, the transverse direction 197(60) illustrates the transverse direction 197 at the transverse anamorphic component 60 formed by the transverse lens 61; the transverse direction 197(110) illustrates the transverse direction 197 at the lateral anamorphic component 110; and the transverse direction 197(44) illustrates the transverse direction 197 at the eye 45 of the viewer 47. The transverse anamorphic component 60 has lateral direction 195(60) that is the same as the lateral direction 195(110) of the lateral anamorphic component 110 and the lateral direction 195(44) at the pupil 44 of the eye 45. The Euclidian coordinate system illustrated by x, y, z directions is invariant, whereas the transverse direction 197, lateral direction 195 and optical axis direction 199 may be transformed at various optical components, in particular by reflection from optical components, of the ANEDA 100.

Further features of the arrangement of FIG. 2A will now be described.

The optical apparatus 250 may comprise an input linear polariser 70 disposed between the SLM 48 and the reflectors 117 and disposed between the SLM 48 and the PSR 700 of the extraction waveguide 1; and is arranged to pass light having the input linear polarisation state 902. In FIG. 2A, the input linear polariser 70 is arranged between the transverse anamorphic component 60 and the extraction waveguide 1. The input linear polariser 70 is an absorbing polariser such as a dichroic iodine polariser arranged to transmit a linear polarisation state and absorb the orthogonal polarisation state. In alternative embodiments the linear polariser 70 may be arranged between the transverse anamorphic component 60 and the SLM 48 or may be the output polariser of the SLM 48.

Further the optical apparatus 250 may comprise a polarisation conversion retarder 72 disposed between the light reversing reflector 140 and the deflection arrangement 112 that may be an A-plate with an optical axis direction arranged to convert linearly polarised light to circularly polarised light and circularly polarised light to linearly polarised light.

In operation, extraction waveguide 1 is arranged to guide light rays 400 propagating in the first direction 191 between the dichroic stack 712 and the front guide surface 8 as illustrated by the zig-zag paths of guided rays 401, 402.

Waveguide 1 further comprises a reflective end 4 arranged to receive the guided light rays 401, 402 from the input end 2. The lateral anamorphic component 110 comprises the reflective end 4 of the extraction waveguide 1 with a reflective material provided on the reflective end 4. The reflective material may be a reflective film such as ESR™ from 3M or may be an evaporated or sputtered metal material such as aluminium or silver. In the embodiment of FIG. 2A, the lateral anamorphic component 110 is thus a curved mirror with positive optical power in the lateral direction 195 and no optical power in the transverse direction 197.

For light rays 400 propagating in the second direction 193, the extraction waveguide is arranged to provide guiding between the front guide surface 8 and the guide facet 174 or between the front guide surface 8 and the guide portion 178. In the second direction 193, light is transmitted through the dichroic stack 712.

For light cone 493 propagating in the second direction 193, the reflectors 117A-D are oriented to extract light guided back along the extraction waveguide 1 in the second direction 193 through the front guide surface 8 and towards the pupil 44 of eye 45 arranged in eyebox 40.

FIG. 2C illustrates an ANEDA in use as the near-eye display apparatus 100 of FIGS. 1A-C. When an ANEDA such as the ones described herein is used as the near-eye display apparatus 100 in combination with a ring-shaped band 802 of the device 800, the size of the exit pupil 40 of the display apparatus can be much smaller than that for conventional head-mounted eyewear (such as AR or VR glasses). This is because the relative position of the user's eye 45 with respect to the ANEDA 100 is manually adjusted by the user moving the device 800 so that the eye's pupil 44 falls within the exit pupil 40, as illustrated by FIG. 2C.

By comparison in conventional head-mounted eyewear such as car-and-nose-mounted AR spectacles or head-and-face-mounted VR headsets, the location of the near-eye display apparatus is fixed with respect to the eye 45 socket, and movement of the near-eye display apparatus 100 is not possible. Such eyebox 40 needs to be much bigger than the pupil 44 to take into account eye movements and different interocular separations.

TABLE 1 provides details of an illustrative example of a device 800 comprising ANEDA 100 and ring-shaped band 802 of FIGS. 1A-C and FIGS. 2A-C for wearing on a digit 49 as illustrated in FIG. 1D. More specifically, TABLE 1 provides dimensions and values for various physical and optical properties for various components of the ANEDA 100 plus ring-shaped band 802 combination.

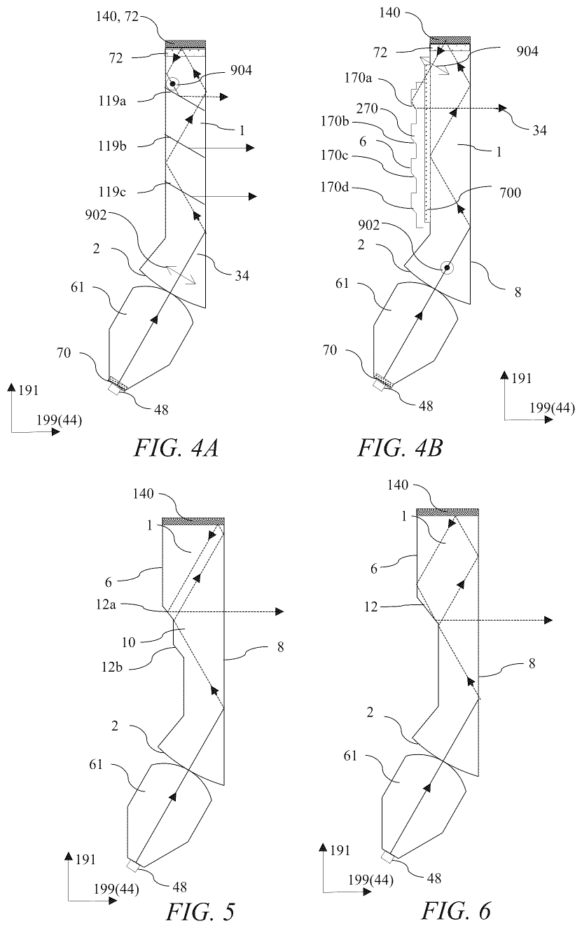

TABLE 1

| Item | Property | Specification | |
|---|---|---|---|
| SLM 48 | Lateral direction 195(48) pixel number | 320 | |
| | Transverse direction 197(48) pixel number | 240 | |
| | Lateral direction 195(48) colour sub-pixel | 0.001 | mm |
| | size | | |
| | Transverse direction 197(48) colour | 0.001 | mm |
| | sub-pixel size | | |
| | Lateral direction 195(48) size | 0.96 | mm |
| | Transverse direction 197(48) size | 0.24 | mm |
| Transverse lens | Transverse direction 197(61) focal length | 2.6 | mm |
| 61 | Lateral direction 195(61) size | 5.0 | mm |
| | Transverse direction 197(61) size | 1.7 | mm |
| Waveguide 1 | Thickness | 1 | mm |
| | Lateral direction 195(1) size | 5.0 | mm |
| | Transverse direction 197(1) size | 8.5 | mm |
| | Light reversing reflector 140 radius of | 17 | mm |
| | curvature | | |
| | Refractive index | 1.50 | |
| Deflection | Lateral direction 195(118) size | 5.0 | mm |
| features 118 | Transverse direction 197(118) pitch | 1.15 | mm |
| | Transverse direction 197(118) | 60° | |
| | inclination θ | | |
| Deflection | Location | See FIG. 4A | |
| arrangement | | | |
| 112 | | | |
| Ring-shaped | Inner diameter 820 | 20 | mm |
| band 802 | Thickness 822 | 3 | mm |
| | Width 824 | 8 | mm |
| Image 36 & | Lateral direction 197(45) field of view | 10° | |
| Eyebox 40 | Transverse direction 195(45) field of view | 7.5° | |
| | Eye relief eR | 4 | mm |
| | Lateral direction 195(45) eyebox 40 eL | 4 | mm |
| | Transverse direction 197(45) eyebox 40 | 4 | mm |
| | eT | | |

As can be seen from TABLE 1, a 5 mm wide waveguide for the ANEDA would provide an exit pupil 40 width of approximately 4 mm at a 4 mm eye relief, which is also much smaller than the eye relief er of typical head-mounted displays which are typically in the range 10˜20 mm. Thus, by way of comparison with conventional head-mounted near-eye displays the ANEDA 100 of the embodiments described herein may be provided with physical dimensions that are substantially smaller, advantageously achieving reduced cost and bulk when worn. Further the size of the eyebox 40 would be too small for conventional eye relief in a head-worn near-eye display. It will be appreciated that the advantages described above with reference to TABLE 1 are generally applicable to all of the embodiments described herein and TABLE 1 merely describes one specific example for the purposes of illustration.

Referring again to FIG. 2B, the thickness t of the ANEDA 100 may refer to the thickness of the waveguide 1 and the deflection arrangement 112. The optical axis 199(60) of the transverse anamorphic component 60 may be rotated in comparison to the optical axis 199(1) of the waveguide 1 and a tapered surface 18 arranged to reduce or remove double imaging. Such arrangement may be arranged to be rotated in the same sense that the band 802 is curved, to achieve desirable mechanical fit within the band.

When the ring-shaped band 802 is sized for extending and fitting around a digit 49 of the user 47, a thickness of the near-eye display apparatus 100 may be between 0.5 mm and 3 mm and preferably between 0.75 mm and 2 mm. A compact ANEDA 100 may be comprised that may be embedded in a ring-shaped band 802 suitable for comfortable wearing on a digit, while achieving desirable image uniformity in use when held near the eye 45 of a user 47.

TABLE 2 provides details of an illustrative example of a device 800 comprising ANEDA 100 and ring-shaped band 802 of FIGS. 1A-C and FIGS. 2A-C for wearing on an arm 51 as illustrated in FIG. 1E. More specifically, TABLE 2 provides dimensions and values for various physical and optical properties for various components of the ANEDA 100 plus ring-shaped band 802 combination.

TABLE 2

| Item | Property | Specification | |
|---|---|---|---|
| SLM 48 | Lateral direction 195(48) pixel number | 640 | |
| | Transverse direction 197(48) pixel number | 480 | |
| | Lateral direction 195(48) colour sub-pixel | 0.001 | mm |
| | size | | |
| | Transverse direction 197(48) colour | 0.001 | mm |
| | sub-pixel size | | |
| | Lateral direction 195(48) size | 1.92 | mm |
| | Transverse direction 197(48) size | 0.48 | mm |
| Transverse lens | Transverse direction 197(61) focal length | 5.2 | mm |
| 61 | Lateral direction 195(61) size | 10.0 | mm |
| | Transverse direction 197(61) size | 3.4 | mm |
| Waveguide 1 | Thickness | 2 | mm |
| | Lateral direction 195(1) size | 20.0 | mm |
| | Transverse direction 197(1) size | 17 | mm |
| | Light reversing reflector 140 radius of | 34 | mm |
| | curvature | | |
| | Refractive index | 1.50 | |
| Deflection | Lateral direction 195(118) size | 20.0 | mm |
| features 118 | Transverse direction 197(118) pitch | 1.15 | mm |
| | Transverse direction 197(118) inclination | 60° | |
| | θ | | |
| Deflection | Location | See FIG. 2A | |
| arrangement | Thickness | 1.0 | mm |
| 112 | | | |
| Ring-shaped | Inner diameter 820 | 60 | mm |
| band 802 | Thickness 822 | 5 | mm |
| | Width 824 | 30 | mm |
| Image 36 & | Lateral direction 197(45) field of view | 10° | |
| Eyebox 40 | Transverse direction 195(45) field of view | 7.5° | |
| | Eye relief eR | 8 | mm |
| | Lateral direction 195(45) eyebox 40 eL | 8 | mm |
| | Transverse direction 197(45) eyebox 40 | 8 | mm |
| | eT | | |

By way of comparison with TABLE 1, the alternative embodiment of TABLE 2 illustrates a larger ANEDA 100 that is more suitable for wearing on a wrist of the user 47. As can be seen from TABLE 2, a 10 mm wide waveguide for the ANEDA would provide an exit pupil 40 width of approximately 8 mm at an 8 mm eye relief. Such a display may provide improved image uniformity and reduced alignment tolerance, while still being positioned by the user 47 with respect to their eye 45.

The size of the ANEDA 100 may be increased and a larger exit pupil 40 provided to achieve reduced image vignetting. Image resolution may be increased. When the ring-shaped band 802 is sized for extending and fitting around an arm of the user, a thickness t of the near-eye display apparatus 100 may be between 0.75 mm and 5 mm and preferably between 1 mm and 2 mm. A compact ANEDA 100 may be comprised that may be embedded in a ring-shaped band 802 suitable for wearing on an arm 51 such as a wrist, while achieving desirable image uniformity in use when held near the eye 45 of a user 47. Improved brightness, efficiency and size of exit pupil 40 may be achieved.

FIG. 2D is a schematic diagram illustrating a side view of an ANEDA 100 according to a first embodiment; and FIG. 2E is a schematic diagram illustrating a front view of the ANEDA 100 according to the first embodiment of FIG. 2D. Features of the embodiment of FIGS. 2D-E not discussed in further detail may be assumed to correspond to the features with equivalent reference numerals as discussed above, including any potential variations in the features.

In the first embodiment, ANEDA 100 comprises an extraction waveguide 1 which comprises a rear guide surface 6 and a polarisation-sensitive reflector 700 opposing the rear guide surface 6. The ANEDA 100 further comprises a deflection arrangement 112 disposed outside the polarisation-sensitive reflector 700. The ANEDA 100 is arranged to provide light guided along the extraction waveguide 1 in the first direction 191 with an input linear polarisation state 902 before reaching the polarisation-sensitive reflector 700. The ANEDA 100 further comprises a polarisation conversion retarder 72 disposed in the light path between the polarisation-sensitive reflector 700 and the light reversing reflector 140. The polarisation conversion retarder 72 is arranged to convert a polarisation state 902 of light passing therethrough between a linear polarisation state and a circular polarisation state. The polarisation conversion retarder 72 and the light reversing reflector 140 are arranged in combination to rotate the input linear polarisation state 902 of the light guided in the first direction 191 so that the light guided in the second direction 193 and output from the polarisation conversion retarder 72 has a linear polarisation state 904 that is orthogonal to the input linear polarisation state 902. The polarisation-sensitive reflector 700 is arranged to reflect light guided in the first direction 191 having the input linear polarisation state 902 so that the rear guide surface 6 and the polarisation-sensitive reflector 700 are arranged to guide light in the first direction 191, and to extract light guided in the second direction 193 having the orthogonal linear polarisation state so that the extracted light is incident on the deflection arrangement 112. The deflection arrangement 112 is arranged to deflect at least part of the light extracted by the polarisation-sensitive reflector 700 that is incident thereon towards an output direction forwards of the ANEDA 100.

FIG. 3A is a schematic diagram illustrating a side view of propagation of light in an ANEDA; and FIG. 3B is a schematic diagram illustrating a front view of propagation of light in an ANEDA. Features of the embodiment of FIGS. 3A-B not discussed in further detail may be assumed to correspond to the features with equivalent reference numerals as discussed above, including any potential variations in the features. It will be appreciated that FIGS. 3A-B describe mechanisms of light propagation which may apply to any of the ANEDA embodiments described herein.

FIG. 3A illustrates that the transverse anamorphic component 60 comprising lens 61 provides a transverse fan of rays within the waveguide 1 of the ANEDA 100 with central rays 34C and upper rays 34U corresponding to pixels 222C and 222U respectively to achieve a transverse field of view half-angle of ϕ_{T} within the waveguide 1.

Similarly FIG. 3B illustrates that the lateral anamorphic component 110 comprising curved light reversing reflector 140 provides a lateral fan of rays within the waveguide 1 of the ANEDA 100 with middle rays 34M and left rays 34L corresponding to pixels 222M and 222L respectively to achieve a lateral field of view half-angle of ϕ_{L} within the waveguide 1. Output light is refracted into air at the output surface of the deflection arrangement 112.

Illustrative arrangements of SLM 48 will now be described.

FIG. 3C is a schematic diagram illustrating a front view of a SLM 48 comprising red, green and blue sub-pixels 222R, 222G, 222B for use in an ANEDA 100; and FIG. 3D is a schematic diagram illustrating a front view of a spatial light modulator comprising monochromatic sub-pixels 222M for use in an ANEDA 100. Features of the embodiments of FIGS. 3C-D not discussed in further detail may be assumed to correspond to the features with equivalent reference numerals as discussed above, including any potential variations in the features.

FIG. 3C illustrates that the pixels 222 of the SLM 48 may comprise sub-pixels that provide a coloured image 36 and the pixels 222 are distributed in the lateral direction 195. The pixels 222 have pitch P_{L} in the lateral direction 195 and pitch P_{T} in the transverse direction 197, and the optical apparatus 250 of the ANEDA 100 is arranged to provide substantially square pixel arrangements to the image 36 on the retina 46 of the eye 45.

By way of comparison with FIG. 3C, the alternative embodiment of FIG. 3D illustrates that a monochromatic image may be provided. Increased efficiency and reduced cost and complexity of the SLM 48 may be achieved.

In alternative embodiments (not shown), the pixels 222 may be provided by scanning light sources such as lasers. The pixels 222 may be provided by an array of light sources across the lateral direction 195 and may be scanned in the transverse direction 197.

Alternative arrangements of ANEDA 100 will now be described.

FIG. 4A is a schematic diagram illustrating a side view of an ANEDA 100 according to a second embodiment. Features of the embodiment of FIG. 4A not discussed in further detail may be assumed to correspond to the features with equivalent reference numerals as discussed above, including any potential variations in the features.

In the second embodiment, the ANEDA 100 comprises an extraction waveguide 1 which comprises an array of extraction features 119 disposed internally within the extraction waveguide, the extraction features 118 being arranged to transmit light guided along the extraction waveguide 1 in the first direction 191 and to extract light guided along the extraction waveguide in the second direction 193 towards an eye of a viewer. The array of extraction features 118a-c wherein in FIG. 4A facets 119a, 119b and 119c are provided are distributed along the extraction waveguide so as to provide exit pupil 40 expansion.

The extraction features 119 may be provided with polarisation sensitive layers, such as a dichroic or birefringent stack of layers. In operation, at least some light ray 34 is transmitted by the extraction features 119 when propagating in the first direction 191 with a first polarisation state 902 and after reflection from the light reversing reflector light with the second polarisation state 904 is reflected by the extraction features 119.

By way of comparison with FIGS. 2A-B, the alternative embodiment of FIG. 4A may achieve reduced thickness, complexity and cost.

ANEDA 100 of the type of FIG. 4A and variations thereof are described in U.S. Patent Publ. No. 2023-0418034 (Atty. Ref. 489001), which is herein incorporated by reference in its entirety.

FIG. 4B is a schematic diagram illustrating a side view of an ANEDA 100 according to a third embodiment. Features of the embodiment of FIG. 4B not discussed in further detail may be assumed to correspond to the features with equivalent reference numerals as discussed above, including any potential variations in the features.

In the third embodiment, the ANEDA 100 comprises an extraction waveguide 1 which comprises a front guide surface 8, a polarisation-sensitive reflector 700 opposing the front guide surface 8, and an extraction element 270 disposed outside the polarisation-sensitive reflector 700. The extraction element 270 comprises a rear guide surface 6 opposing the front guide surface 8, and an array of extraction features 170. The ANEDA 100 is arranged to provide light guided along the extraction waveguide 1 in the first direction 191 with an input linear polarisation state before reaching the polarisation-sensitive reflector 700. The ANEDA 100 further comprises a polarisation conversion retarder 72 disposed between the polarisation-sensitive reflector 700 and the light reversing reflector 140. The polarisation conversion retarder 72 is arranged to convert a polarisation state of light passing therethrough between a linear polarisation state and a circular polarisation state. The polarisation conversion retarder and the light reversing reflector 140 are arranged in combination to rotate the input linear polarisation state of the light guided in the first direction so that the light guided in the second direction and output from the polarisation conversion retarder has an orthogonal linear polarisation state that is orthogonal to the input linear polarisation state. The polarisation-sensitive reflector 700 is arranged to reflect light guided in the first direction 191 having the input linear polarisation state and to extract light guided in the second direction 193 having the orthogonal linear polarisation state, so that the front guide surface 8 and the polarisation-sensitive reflector 700 are arranged to guide light in the first direction 191, and the front guide surface 8 and the rear guide surface 6 are arranged to guide light in the second direction 193. The array of extraction features 170 is arranged to extract light guided along the extraction waveguide 1 in the second direction 193 towards an eye of a viewer through the front guide surface 8, the array of extraction features being distributed along the extraction waveguide I so as to provide exit pupil expansion in the transverse direction.

By way of comparison with FIGS. 2A-B, the alternative embodiment of FIG. 4B provides extraction features 170 that may be formed by moulding such as UV casting or injection moulding. Reduced complexity and cost may be achieved.

ANEDA 100 of the type of FIG. 4B and variations thereof are described in U.S. Patent Publ. No. 2024-0061248 (Atty. Ref. 493001), which is herein incorporated by reference in its entirety.

FIG. 5 is a schematic diagram illustrating a side view of an ANEDA 100 according to a fourth embodiment. Features of the embodiment of FIG. 5 not discussed in further detail may be assumed to correspond to the features with equivalent reference numerals as discussed above, including any potential variations in the features.

In the fourth embodiment, the extraction waveguide 1 comprises an input end 2, and first and second, opposed guide surfaces 8, 6 for guiding light along the waveguide 1. The first guide surface 8 is arranged to guide light by total internal reflection. The second guide surface 6 has a stepped shape comprising a plurality of facets 12a, 12b extending in a lateral direction across the waveguide 1 and orientated to reflect input light from the input end 2 through the first guide surface 8 as output light. The second guide surface 6 also has intermediate regions 10 between the facets 12a, 12b that are arranged to direct light through the waveguide 1 without extracting it.

By way of comparison with FIGS. 2A-B and FIGS. 4A-B, the alternative embodiment of FIG. 5 comprises extraction features that may be moulded at low cost as part of the waveguide 1, or alternatively attached to a waveguide member (not shown). Further, no polarisation-sensitive reflector 700 is provided, reducing cost and complexity.

FIG. 6 is a schematic diagram illustrating a side view of an ANEDA 100 according to a fifth embodiment. The fifth embodiment is the same as the fourth embodiment of FIG. 5, except that there is only one facet 12. Features of the embodiment of FIG. 6 not discussed in further detail may be assumed to correspond to the features with equivalent reference numerals as discussed above, including any potential variations in the features.

By way of comparison with FIG. 5, the alternative embodiment of FIG. 6 illustrates that an extraction feature that comprises a single facet 12 may be provided without intermediate regions 10.

ANEDA 100 of the type of FIG. 5 and FIG. 6 comprising inclined facets 12 and variations thereof are described in U.S. Pat. No. 9,594,261 (Atty. Ref. 315001), which is herein incorporated by reference in its entirety.

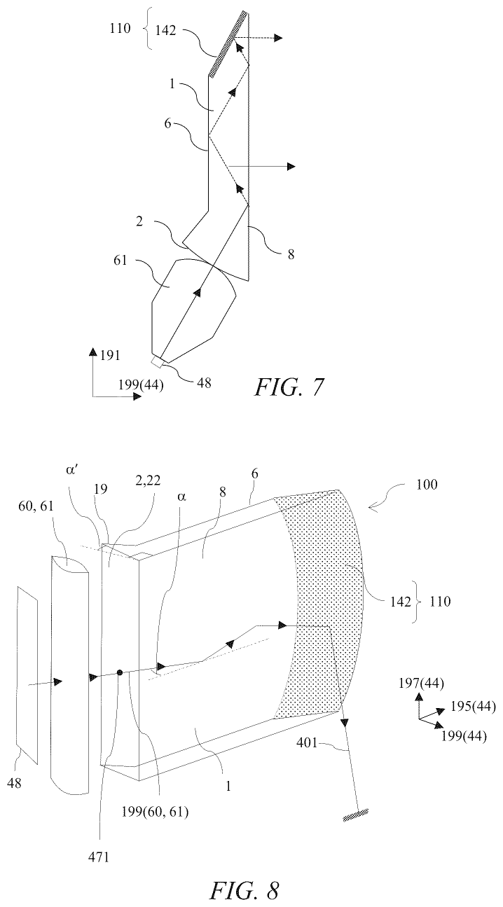

FIG. 7 is a schematic diagram illustrating a side view of an ANEDA 100 according to a sixth embodiment; and FIG. 8 is a schematic diagram illustrating a perspective front view of the ANEDA 100 according to the sixth embodiment. Features of the embodiments of FIGS. 7-8 not discussed in further detail may be assumed to correspond to the features with equivalent reference numerals as discussed above, including any potential variations in the features.

In the sixth embodiment, the ANEDA 100 comprises an extraction waveguide 1 which comprises front and rear guide surfaces 8, 6 arranged to guide light from the transverse anamorphic component along the waveguide 1, and an extraction reflector 142 arranged to reflect light that has been guided along the waveguide 1. The extraction reflector 142 is a lateral anamorphic component 110 having positive optical power in the lateral direction and the extraction reflector 540 is oriented to extract light out of the waveguide 1 through at least one of the guide surfaces 8, 6 as output illumination.

In the sixth embodiment, the direction of the optical axis 199 through the transverse anamorphic component 60 is inclined at an acute angle a with respect to the front and rear guide surfaces 8, 6 of the waveguide 1 and the input face 22 is inclined at an acute angle α′ with respect to the front and rear guide surfaces 8, 6 of the waveguide 1. The acute angles α, α′ may be the same and in operation, light rays that are parallel to the optical axis 199(60) are passed through the input face 22, for example at illustrative point 471, without deviating due to refraction. Advantageously reduced aberrations are achieved for on-axis light. Further, the light cones are arranged to guide along the waveguide at angles different to directions along the waveguide in the transverse direction 197(1).

By way of comparison with FIG. 6, the alternative embodiments of FIGS. 7-8 do not reflect light in the second direction 193 along the waveguide 1. Stray light may be reduced and advantageously image 36 contrast improved.

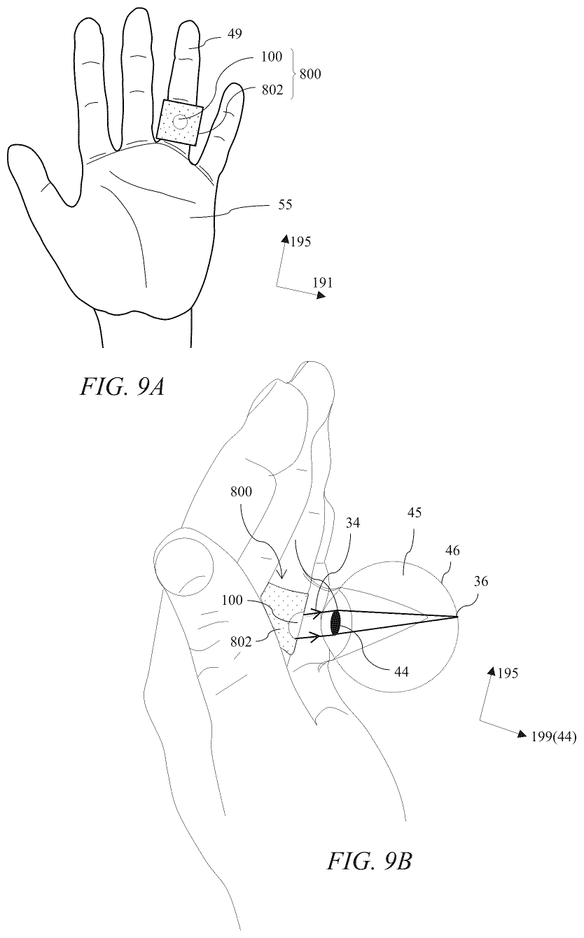

FIG. 9A is a schematic diagram illustrating a front view of the ring-shaped band 802 with the near-eye display apparatus 100 being worn on a digit of a user; and FIG. 9B is a schematic diagram illustrating a perspective side view of the ring-shaped band 802 with the near-eye display apparatus 100 being worn on a digit of a user and providing an image to an eye of the user. Features of the embodiments of FIGS. 9A-B not discussed in further detail may be assumed to correspond to the features with equivalent reference numerals as discussed above, including any potential variations in the features.

When the user brings the near-eye display 100 up close to their eye 45, the output light 34 from the near-eye display 100 enters the pupil 44 of the eye 45 and provides an image 36 at the retina 46.

In operation, the ring-shaped band 802 is brought into proximity to the eye of the user 47 by means of hand 55 or arm 51 movement. Such alignment may be provided for a smaller exit pupil 44 of the ANEDA 100 in comparison to that provided by typical head-mounted near-eye displays. Cost and complexity of the waveguide 1 may be reduced. Further, image 36 uniformity may be improved.

FIG. 10A is a schematic diagram illustrating a side view of ring-shaped band, an ANEDA and further comprising a direct view SLM 348; FIG. 10B is a schematic diagram illustrating a side view of an alternative ring-shaped band, comprising an ANEDA 100 and a direct view SLM 348 and FIG. 10C is a schematic diagram illustrating a side view of a user using the direct view SLM 348 of FIG. 10A in a direct view mode. Features of the embodiments of FIGS. 10A-C not discussed in further detail may be assumed to correspond to the features with equivalent reference numerals as discussed above, including any potential variations in the features.

The display device 880 further comprises a direct view display apparatus that in the embodiment of FIGS. 10A-C is a direct view SLM 348, the direct view display apparatus being arranged to direct light through the near-eye display apparatus 100. The direct view SLM 348 is different to the SLM 48 and is not imaged by the optical apparatus 250. The alternative embodiment of FIG. 10A illustrates that the direct view SLM 348 may additionally be provided as part of the device 800, so that the light from the direct view SLM 348 passes through the optical apparatus 250 of the ANEDA 100, being transmitted by the waveguide 1 and deflection arrangement 112.

The direct view SLM 348 may comprise an OLED display, a micro-LED display or an LCD display for example. The output light 334 from the direct view SLM 348 may be linearly polarised. The polarisation state 304 that is output from the direct view SLM 348 may be different to the polarisation state 904 that is output from the ANEDA 100, and the polarisation states 904, 304 may be orthogonal. Advantageously the brightness of the SLM 348 and ANEDA 100 may be maintained.

By way of comparison with FIG. 1A, the alternative embodiment of FIG. 10B illustrates a transparent output window 350 that may be arranged to receive the output light 34 or the output light 334. The thickness 822 of the ring-shaped band 802 is greater in the region of the display device 100 in comparison to the thickness 823 in the region of the strap of the ring-shaped band 802. Advantageously the weight of the device 800 is reduced, and wearing comfort and aesthetic appearance may be improved.

By way of comparison with FIG. 1E, the embodiment of FIG. 10C illustrates that the device 800 may be provided for example as part of a watch device and the SLM 348 may be directly viewed through the ANEDA 100 at a viewing distance eD such as 100 mm or greater. The ANEDA may be switched off in the use of FIG. 10C.

It will be appreciated that the additional direct view SLM 348 of FIGS. 10A-C may be used in combination with any of the ANEDA 100 embodiments described above.

As may be used herein, the terms “substantially” and “approximately” provide an industry-accepted tolerance for its corresponding term and/or relativity between items. Such an industry-accepted tolerance ranges from zero percent to ten percent and corresponds to, but is not limited to, component values, angles, et cetera. Such relativity between items ranges between approximately zero percent to ten percent.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the embodiment(s) set out in any claims that may issue from this disclosure. Specifically and by way of example, although the headings refer to a “Technical Field,” the claims should not be limited by the language chosen under this heading to describe the so-called field. Further, a description of a technology in the “Background” is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

What is claimed is:

1. A device for wearing by a user, the device comprising:
a ring-shaped band sized for extending and fitting around an arm or digit of the user; and
a near-eye display apparatus attached to the ring-shaped band for displaying an image to the user,
wherein the near-eye display apparatus comprises:
a spatial light modulator; and
an optical apparatus,
wherein the spatial light modulator is arranged to output light via the optical apparatus to provide the image for display,
wherein the optical apparatus has an optical axis and positive optical power in lateral and transverse directions that are perpendicular to each other and perpendicular to the optical axis, and
wherein the optical apparatus has anamorphic properties in the lateral and transverse directions.

2. The device of claim 1, wherein the optical apparatus comprises an extraction waveguide.

3. The device of claim 2, wherein:
the spatial light modulator comprises pixels distributed in the lateral direction, and
the optical apparatus comprises:
a transverse anamorphic component having positive optical power in the transverse direction, wherein the transverse anamorphic component is arranged to receive light from the spatial light modulator and to output light in directions that are distributed in the transverse direction, wherein the extraction waveguide is arranged to receive the light output from the transverse anamorphic component;
a lateral anamorphic component having positive optical power in the lateral direction, wherein the extraction waveguide is arranged to guide light from the transverse anamorphic component to the lateral anamorphic component along the extraction waveguide in a first direction; and
a light reversing reflector that is arranged to reflect light guided along the extraction waveguide in the first direction such that the reflected light is directed along the extraction waveguide in a second direction opposite to the first direction.

4. The device of claim 3, wherein:
the extraction waveguide comprises a rear guide surface and a polarisation-sensitive reflector opposing the rear guide surface,
the near-eye display apparatus further comprises a deflection arrangement disposed outside the polarisation-sensitive reflector,
the near-eye display apparatus is arranged to provide light guided along the extraction waveguide in the first direction with an input linear polarisation state before reaching the polarisation-sensitive reflector,
the optical apparatus further comprises a polarisation conversion retarder disposed in the light path between the polarisation-sensitive reflector and the light reversing reflector, wherein the polarisation conversion retarder is arranged to convert a polarisation state of light passing therethrough between a linear polarisation state and a circular polarisation state, and the polarisation conversion retarder and the light reversing reflector are arranged in combination to rotate the input linear polarisation state of the light guided in the first direction so that the light guided in the second direction and output from the polarisation conversion retarder has a linear polarisation state that is orthogonal to the input linear polarisation state,
the polarisation-sensitive reflector is arranged to reflect light guided in the first direction having the input linear polarisation state so that the rear guide surface and the polarisation-sensitive reflector are arranged to guide light in the first direction, and to extract light guided in the second direction having the orthogonal linear polarisation state so that the extracted light is incident on the deflection arrangement, and
the deflection arrangement is arranged to deflect at least part of the light extracted by the polarisation-sensitive reflector that is incident thereon towards an output direction forwards of the near-eye display apparatus.

5. The device of claim 3, wherein:
the extraction waveguide comprises:
a front guide surface;
a polarisation-sensitive reflector opposing the front guide surface; and
an extraction element disposed outside the polarisation-sensitive reflector,
the extraction element comprises:
a rear guide surface opposing the front guide surface; and
an array of extraction features,
the near-eye display apparatus is arranged to provide light guided along the extraction waveguide in the first direction with an input linear polarisation state before reaching the polarisation-sensitive reflector,
the optical apparatus further comprises a polarisation conversion retarder disposed between the polarisation-sensitive reflector and the light reversing reflector, wherein the polarisation conversion retarder being arranged to convert a polarisation state of light passing therethrough between a linear polarisation state and a circular polarisation state, and the polarisation conversion retarder and the light reversing reflector are arranged in combination to rotate the input linear polarisation state of the light guided in the first direction so that the light guided in the second direction and output from the polarisation conversion retarder has an orthogonal linear polarisation state that is orthogonal to the input linear polarisation state, and
the polarisation-sensitive reflector is arranged to reflect light guided in the first direction having the input linear polarisation state and to extract light guided in the second direction having the orthogonal linear polarisation state, so that the front guide surface and the polarisation-sensitive reflector are arranged to guide light in the first direction, and the front guide surface and the rear guide surface are arranged to guide light in the second direction; and
the array of extraction features is arranged to extract light guided along the extraction waveguide in the second direction towards an eye of a viewer through the front guide surface, the array of extraction features being distributed along the extraction waveguide so as to provide exit pupil expansion in the transverse direction.

6. The device of claim 3, wherein the extraction waveguide comprises an array of extraction features disposed internally within the extraction waveguide, the extraction features being arranged to transmit light guided along the extraction waveguide in the first direction and to extract light guided along the extraction waveguide in the second direction towards an eye of a viewer, the array of extraction features being distributed along the extraction waveguide so as to provide exit pupil expansion.

7. The device of claim 3, wherein the extraction waveguide comprises an input end, and first and second, opposed guide surfaces for guiding light along the waveguide, the first guide surface being arranged to guide light by total internal reflection and the second guide surface having a stepped shape comprising a plurality of facets extending in a lateral direction across the waveguide and orientated to reflect input light from the input end through the first guide surface as output light, and intermediate regions between the facets that are arranged to direct light through the waveguide without extracting it.

8. The device of claim 3, wherein the extraction waveguide comprises:
front and rear guide surfaces arranged to guide light from the transverse anamorphic component along the waveguide; and
an extraction reflector arranged to reflect light that has been guided along the waveguide, wherein the extraction reflector is a lateral anamorphic component having positive optical power in the lateral direction and the extraction reflector is oriented to extract light out of the waveguide through at least one of the guide surfaces as output illumination.

9. The device of claim 2, wherein the spatial light modulator comprises inorganic micro-LED pixels or OLED pixels.

10. The device of claim 1, wherein the ring-shaped band is sized for extending and fitting around a digit of the user, and wherein a thickness of the near-eye display apparatus is between 0.5 mm and 3 mm.

11. The device of claim 1, wherein the ring-shaped band is sized for extending and fitting around an arm of the user, and wherein a thickness of the near-eye display apparatus is between 2 mm and 4 mm.

12. The device of claim 1, wherein the image displayed by the near-eye display apparatus is monochrome.

13. The device of claim 1, wherein the image is for projection into the pupil of the eye.

14. The device of claim 1, wherein the near-eye display apparatus is at least partially embedded within the ring-shaped band.

15. The device of claim 1, wherein the near-eye display apparatus is configured to receive electronic signals for displaying the image.

16. The device of claim 1, wherein the ring-shaped band has a gap to enable the ring-shaped band to flex to facilitate close fitting to the digit or arm of the user and/or removal of the ring-shaped band from the digit or arm of the user.

17. The device of claim 1, further comprising a direct view display apparatus, the direct view display apparatus being arranged to direct light through the near-eye display apparatus.

18. A device for wearing by a user, the device comprising:
a ring-shaped band sized for extending and fitting around an arm or digit of the user; and
a near-eye display apparatus attached to the ring-shaped band for displaying an image to the user,
wherein the near-eye display apparatus comprises:
a spatial light modulator; and
an optical apparatus,
wherein the spatial light modulator is arranged to output light via the optical apparatus to provide the image for display.

19. The device of claim 18, wherein the optical apparatus has an optical axis and positive optical power in lateral and transverse directions that are perpendicular to each other and perpendicular to the optical axis.

20. A device for wearing by a user, the device comprising:
a ring-shaped band sized for fitting around a digit of the user, and
a near-eye display apparatus attached to the ring-shaped band for displaying an image to the user.
